(19) United States
(12) Patent Application Publication
(10) Pub. No.: US 2012/0005483 A1
(43) Pub. Date: Jan. 5, 2012

(54) Method for Image-Based Authentication

(75) Inventors: Jozsef Patvarczki, Framingham, MA (US); Adam Kornafeld, Nyiregyhaza (HU); Endre Tamas, Worcester, MA (US)

(73) Assignee: HYDRABYTE, INC., Worcester, MA (US)

(21) Appl. No.: 12/753,225

(22) Filed: Apr. 2, 2010

Related U.S. Application Data
(60) Provisional application No. 61/168,024, filed on Apr. 9, 2009.

(51) Int. Cl. G06F 21/00

(52) U.S. Cl. 713/182; 726/2

(57) ABSTRACT

A method for authenticating user access to a restricted resource that presents a login screen with an image separated into sections. To login, the user triggers sections in a preset sequence that is set up at account creation. At account creation, a cryptographic hash function is applied to a chosen sequence of sections to generate the user's account code. Optionally, elements of the image and/or the user name are included. The user invokes the login screen when access to a restricted resource is desired. The user must change login settings if any parameters, such as a particular image, are elements of the account code. The user triggers the sections in the appropriate order. The cryptographic hash function is applied to the section sequence and any optional elements to generate the login code, which is compared to the stored account codes to either grant or deny access to the restricted resource.

### CROSS-REFERENCES TO RELATED APPLICATIONS

The applicant wishes to claim the benefit of U.S. Provisional Patent Application No. 61/168,024, filed Apr. 9, 2009 for SYSTEM AND METHOD FOR IMAGE-BASED AUTHENTICATION in the names of Jozsef Patvarczki, Adam Kornafeld, and Endre Tamas.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISK APPENDIX

Not Applicable

### BACKGROUND OF THE INVENTION

1. Field of the Invention

The present invention relates to user authentication, more particularly, to a method for authenticating a user for access to restricted resources that does not rely on a password.

2. Description of the Related Art

User authentication is a common task in many applications. Credit cards are authenticated with PIN numbers and service providers usually present users with an authentication interface to prevent unauthorized people from accessing the service. The most common method of authentication is through usernames and passwords.

Although the use of passwords can be an effective way to authenticate users, this method has several drawbacks. Passwords can be hard to remember, even easy to forget, thus preventing the user from accessing the restricted service or information. With the widespread use of online services, password stealing is an everyday hazard. Entering alphanumeric characters as passwords can be inconvenient when electronic devices without a keyboard or with a truncated keyboard are used. Thus, it is desirable to provide user authentication that is simpler, yet safer than the present authentication methods.

### BRIEF SUMMARY OF THE INVENTION

The present invention is a method for authenticating user access to restricted resources such as a software application. The method presents a login screen to the user that displays an image separated into sections by a grid. Each section is assigned a unique coordinate that identifies that section's position in the image. The user triggers each section in a preset sequence.

The preset sequence of sections is set up when the user creates a user account for access to the restricted resource. The user account can have optional information such as personal information and a user name. Setting up the section sequence is mandatory. The user can set a number of parameters to change the look and feel of the authentication system. The user can change the grid size and grid appearance. The grid can appear as a rectangular grid or a combination of other shapes. The user can display section identifiers that are unique to each section. The section identifiers can be used to trigger a section using a keyboard or similar input device. The user can select an image to be displayed, either from a list of predefined images or an installed personal image. The personal images can be stored locally, on the authentication server, or on a portable device for carrying to the place of login.

The user generates the section sequence by triggering image sections in the desired order. After the user has triggered the sections in the desired order, the account creation routine applies a predetermined cryptographic hash function on the coordinates of the sequence of sections to generate the user's account code, which is then stored with the user's account information.

Optionally, to enhance security, the sequence can be combined with elements of the image and/or the user name. Optionally, to enhance security, sections of the image can be rendered in three dimensions on a geometrical object and each side of the object can be rotated into a proper position to authenticate the user.

When the user wishes access to a restricted resource, he invokes a login screen. If desired or required, the user can change login settings. In some instances, the user must change login settings because one or more of the parameters is an element of the account code. For example, if the image is an element of the account code, the correct image must be selected. After any settings changes are made, the user triggers the sections in the appropriate order. The predetermined cryptographic hash function is applied to the coordinates of the sequence of sections and any other optional elements that are needed to generate the login code. The login code is compared to the previously stored account codes, and either grants or denies access to the restricted resource.

Objects of the present invention will become apparent in light of the following drawings and detailed description of the invention.

### BRIEF DESCRIPTION OF THE DRAWINGS

For a fuller understanding of the nature and object of the present invention, reference is made to the accompanying drawings, wherein:

FIG. 1 is a diagram of an example login screen presented to the user in the present invention;

FIG. 2 is a flow diagram of the account creation process;

FIG. 3 is a diagram of an example screen for generating a section sequence;

FIG. 4 is a diagram of an example screen for changing user preferences during account creation;

FIG. 5 is a diagram of another example of a login screen presented to the user;

FIG. 6 is a diagram of the screen of FIG. 3 with visible section identifiers;

FIG. 7 is a diagram of the example screen of FIG. 3 with visible, randomized section identifiers;

FIG. 8 is a diagram of an example screen for choosing an image;

FIG. 9 is a flow diagram of the login process; and

FIG. 10 is a diagram of an example screen for changing user preferences during login.

### DETAILED DESCRIPTION OF THE INVENTION

The present invention is a method for authenticating user access to restricted resources, typically a software application running on an electronic device, such as a desktop computer, laptop computer, personal data assistant (PDA), smart phone, etc. Examples of such applications include a Web service accessed via a browser (e.g., a Web portal providing personalized information), the client side of a client-server application (e.g., the user logs in on the client side and the work done by the client is associated with that particular user on the server side), and a stand-alone application that has restricted functions (e.g., screen lock application of a mobile device to unlock the device).

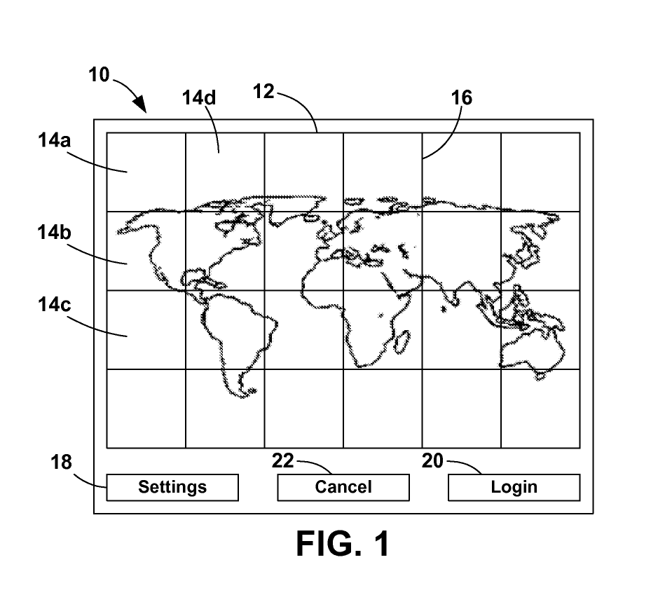

FIG. 1 is a diagram of an illustrative login screen 10 presented to the user by the authentication system of the present invention. The main portion 12 of the screen 10 presents an image 12 that is separated into sections 14a-d (collectively, 14). The image 12 can be any kind of graphic item, such as a photograph, an abstract pattern, a drawing, etc. The sections 14 can be any grouping of parts of the entire image 12 or less than the entire image 12. FIG. 1 shows that the sections 14 are generated by a regular grid pattern 16 that covers the entire image 12. The grid pattern 16 can be superimposed on the image 12 or can be an element of the image 12.

Each section 14 is assigned a unique coordinate that identifies that section's position in the image 12. For example, the coordinate can be generated from a simple rectangular coordinate system such that, for example, section 14a is assigned the horizontal coordinate 1 and the vertical coordinate 1, section 14b is assigned the horizontal coordinate 1 and the vertical coordinate 2, section 14c is assigned the horizontal coordinate 1 and the vertical coordinate 3, section 14d is assigned the horizontal coordinate 2 and the vertical coordinate 1, etc.

Triggering a section 14 of the image 12 serves as an input element for the authentication system. A section 14 can be triggered with a suitable pointing device (e.g., mouse, trackball, finger pad, touch screen) or other input device, as described below, of the electronic device the authentication system is being used on. Optionally, upon triggering, the section 14 provides a brief visual feedback to let the user know whether or not triggering did occur.

Examples of such feedback are inversion of the section, blanking out the section, and outlining the section.

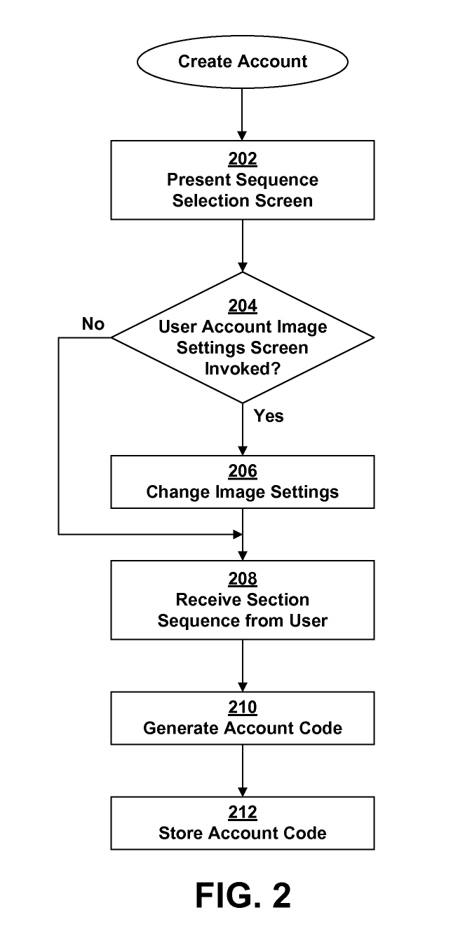

In order to have access to a restricted service or resource, the user creates a user account, as shown in FIG. 2. User account creation can consist of compulsory and optional steps. Optional steps can include entering personal information and/or choosing a user name. A compulsory step 202 is to choose a sequence of sections on the image to be used for authentication.

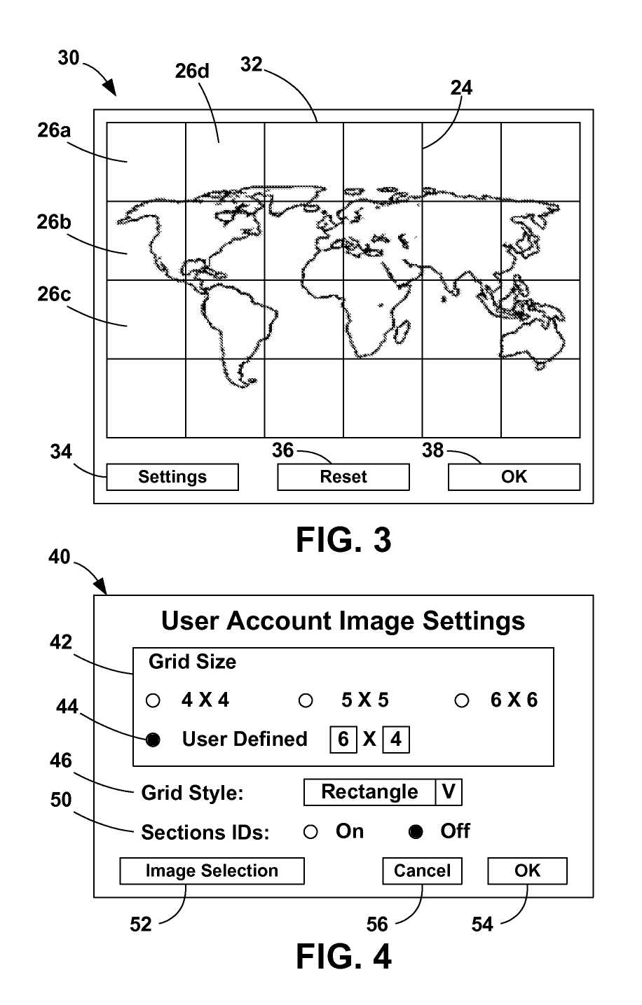

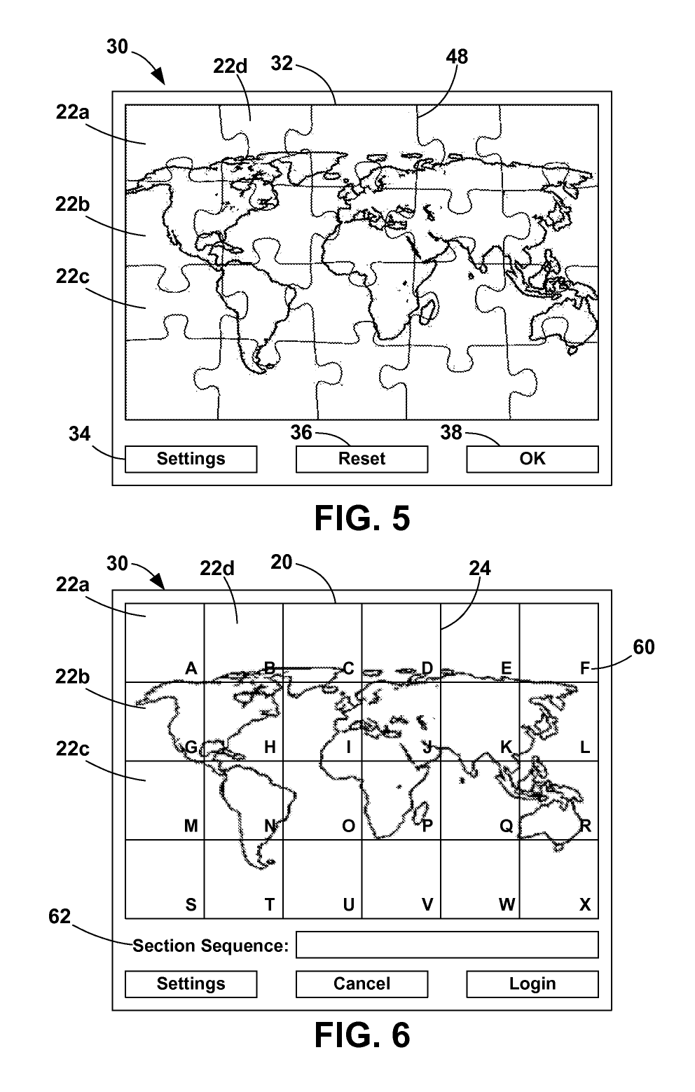

An example of a Sequence Generation screen 30 that is invoked during account creation is shown in FIG. 3. The majority of the screen 30 presents the image 32 that is separated into sections 26a-d (collectively, 26) from which the user generates the sequence. As with the login screen 10 of FIG. 1, the Sequence Generation screen image 32 is separated by a regular grid pattern 24 that covers the entire image 32.

If the Settings button 34 is clicked, as at 204, the User Account Image Settings screen 40 is invoked, as at 206. The User Account Image Settings screen 40, an example of which is shown in FIG. 4, is used to change the look and feel of the authentication system.

The Grid Size selection 42 changes the resolution of the grid 24 used to sectionalize the image 32. In the illustrated example, the Grid Size selection 42 provides several predetermined options and a User Defined option 44. The User Defined option 44 permits the user to set the horizontal and vertical resolution of the grid 24. In the example of FIG. 1, the grid resolution is a custom value of 6×4.

The Grid Style selection 46 provides a way for the user to select the appearance of the grid 24 used to separate the image 32 into sections 26. The Grid Style selection 46 is shown as a drop down list, but can be a set of buttons or other input form. FIG. 1 shows a rectangular grid style, but any suitable grid style can be used to sectionalize the image 32. For example, FIG. 4 illustrates a jigsaw puzzle grid style 48. Other grid styles, such as triangles, hexagons, or any other suitable two-dimensional shapes, or combinations thereof, can be implemented.

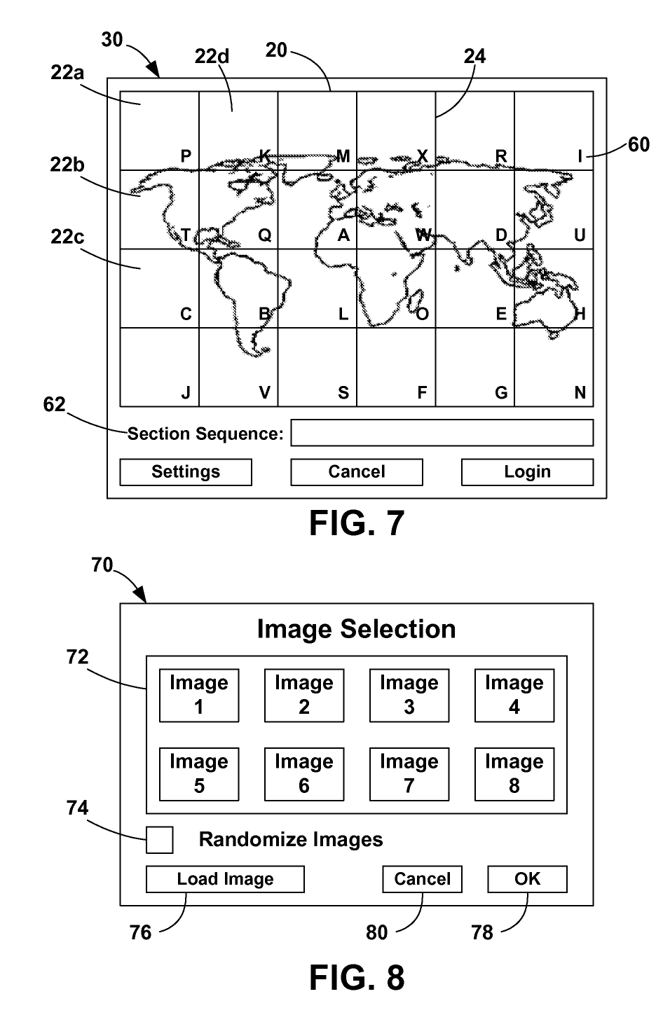

The Section IDs button 50 provides a way to display section identifiers 60 during login. Each section 26 of the image 32 is assigned a unique character or symbol as its section identifier 52, as shown in FIG. 6. This permits a user to trigger a section 26 by entering the corresponding section identifier 60 on a keyboard or into an optional text field 62 on the Sequence Generation screen 30, rather than requiring a pointing device. Alternatively, section identifiers 60 can be implemented as hotkeys and the character-based input device of the electronic device being used can be utilized to trigger the sections 26 needed to input the user's sequence. Optionally, to increase the level of security, the authentication system can assign the section identifiers 60 to the sections 26 randomly, as in FIG. 7.

Alternatively, the grid style can be the appearance of the keyboard and the sequence can be generated by pushing keys that correspond to the desired sections 26 on the image 32.

The optional Image Selection button 52 invokes the Image Selection screen 70, as example of which is shown in FIG. 8. The screen 70 shows a number of predefined images, as at 72, that the user can choose from. A Randomize Images button 74 provides a way to randomly present the predefined images. A Load Image button 76 provides a way for the user to install personal images, rather than being limited to the predefined images. Images provided by the user can be stored locally on the electronic device, uploaded for storage on the authentication server, or stored on a portable device, such as a flash drive, for carrying to the place of login by the user, as described below. The OK button 78 saves the image choice and exits the screen 70. The Cancel button 80 exits the screen 70 without saving the image choice.

The Setting screen OK button 54 saves the setting changes, exits the Settings screen 40, and returns to the Sequence Generation screen 30. The Cancel button 56 exits the Settings screen 40 and returns to the Sequence Generation screen 30 without saving the settings changes.

After the settings are complete, the user generates the sequence by triggering image sections 26 in the desired order, as at 208. For example, the user may generate a sequence by triggering section 26d, section 26a, section 26c, and section 26b, respectively. Optionally, the sequence may be limited to a minimum and/or maximum number of sections 26. Optionally, repeating and/or adjacent sections 26 may not be permitted in the sequence. If the user wishes to restart the sequence, he clicks the Reset button 36.

After triggering each section 26 of the user's sequence in the correct order, the user clicks the OK button 38 to return to the account creation screen. The account creation routine applies a predetermined cryptographic hash function—secure hash and message digest algorithms such as SHA256, SHA384 and SHA512 (defined in Federal Information Processing Standards Publication 180-2) with an optional salt—on the coordinates of the sequence of sections 26 to generate the user's account code.

The account code is stored with the user's account information where it can be accessed by the service that authenticates users. The service may be local as part of the restricted application. Alternatively, the service may be on a separate authentication server for access to restricted remote applications or resources. The login code is sent to the authentication server via a secure channel (e.g., https) over the Internet and stored on the server.

To further enhance security, the sequence can be combined with the binary stream of the image 32, the histogram of the image 32, and/or histograms of sections 26.

Secure hash and message digest algorithms such as SHA256, SHA384 and SHA512 can generate a digest from each selected section 26 of the image and combined into a single digest stream that is hashed with the user's sequence to generate the user's account code. This method provides further security because the image 32 itself becomes a part of the authentication, and the user must use the identical image combined with the particular sequence for the authentication.

To further enhance security, sections 26 of the selected image can be rendered in three dimensions on a geometrical object and each side of the object can be rotated into a proper position to authenticate the user. For example, if each section is a cube, the section 26 can be rotated to one of the six faces of the cube, providing six possible choices for that section 26 rather than only one.

To further enhance security, the user name can be included when generating the account code.

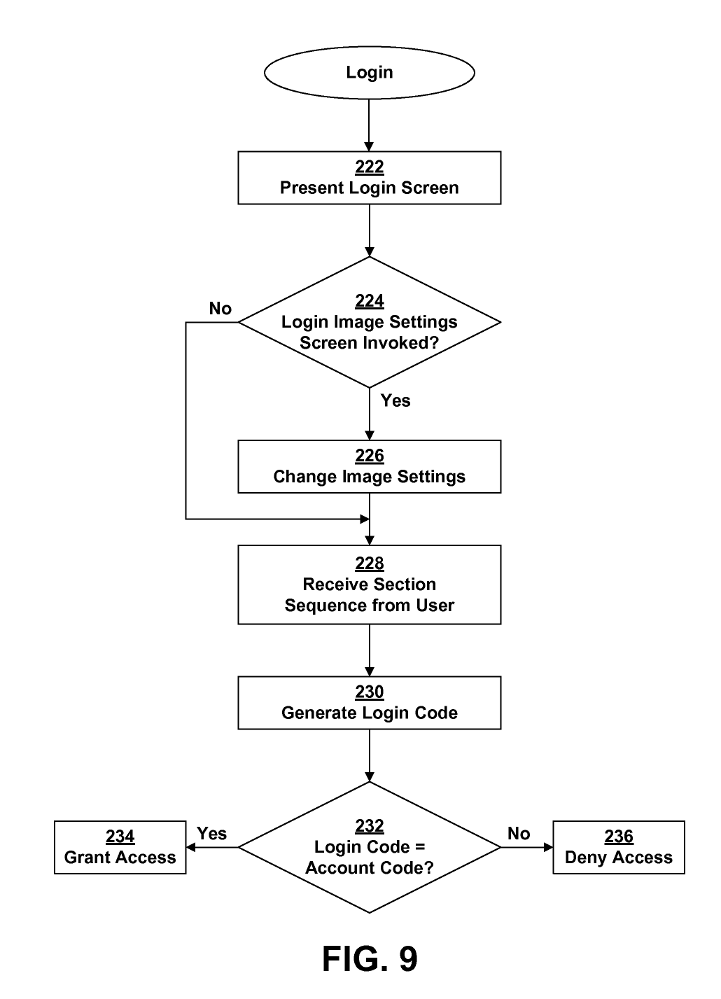

When the user wishes access to a restricted resource, he invokes the login screen 10 of FIG. 1, as at 262 in FIG. 9.

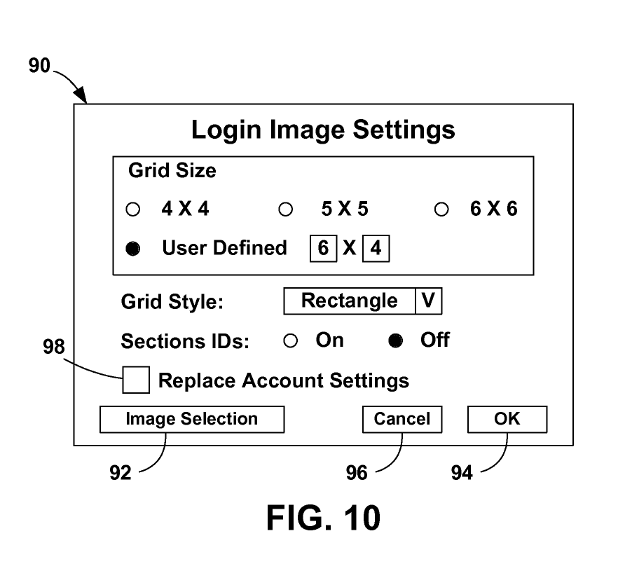

If the Settings button 18 is clicked, as at 264, the Login Image Settings screen 90 is invoked, as at 266. The Login Image Settings screen 90, an example of which is shown in FIG. 10, is used if the user wishes to or must change any of the available system settings. In general, all of the settings available on the User Account Image Settings screen 40 of FIG. 4 are available in the Login

Image Settings screen 90. In some instances, depending on the particular implementation of the present invention, the user must use the Login Image Settings screen 90 because one or more of the changeable parameters are elements of the account code. For example, if the image 12 is an element of the account code, the correct image must be selected via an Image Selection screen invoked by the Image Selection button 92. The Image Selection screen operates in the same way as the account creation Image Selection screen 70 shown in FIG. 8. As described above, images can be provided by the user and stored on a portable device for carrying to the place of login by the user to provide additional security. Such images are loaded in the Image Selection screen.

The OK button 94 saves any settings changes, exits the Login Image Settings screen 90, and returns to the Login screen 10. Any changes made will override the corresponding settings made during account creation for the current login. Optionally, if the Replace Account Settings box 98 is checked, the changes can be made permanent, that is, they can replace the settings made during account creation. The Cancel button 96 exits the Login Image Settings screen 90 and returns to the Login screen 10 without saving any settings changes.

After any changes are made to the settings, the user triggers the sections 14 in the appropriate order for authentication, as at 268, and then clicks the Login button 20.

For the authentication to be successful, the user must trigger the correct sequence on the presented image 12. If the user triggers sections 14 in an incorrect sequence, he can click the Cancel button 22 to reset the input sequence.

After the Login button 20 is clicked, the predetermined cryptographic hash function described above is applied to the coordinates of the sequence of sections 14 and any other optional elements that are needed to generate the login code, as at 230. Because the login code is dependent on the section coordinates, the grid pattern 16 used at login must provide the same section coordinates as the grid pattern 24 used at account creation, otherwise the login code will not match the account code.

The login code is then sent to the authentication service for authentication. As described above, the authentication service can be local as part of the restricted application or can be a remote authentication server. The authentication service compares the login code with the previously stored account codes, as at 232, and replies with a grant of access to the restricted resource, as at 234, or a denial of access to the restricted resource, as at 236, depending on whether or not a match is found, as at 234.

Since certain changes may be made in the present disclosure without departing from the scope of the present invention, it is intended that all matter described in the foregoing specification and shown in the accompanying drawings be interpreted as illustrative and not in a limiting sense.

What is claimed is:

1. A method for authenticating a user for access to a restricted resource comprising the steps of:
(a) creating an account for said user comprising the steps of (1) presenting a first image to said user, said first image being divided into first sections; (2) accepting a first sequence of said first sections selected by said user; (3) generating an account code from said first sequence; and (4) storing said account code; and
(b) subsequently authenticating said user comprising the steps of (1) displaying a second image to said user, said second image being divided into second sections; (2) accepting a second sequence of said second sections selected by said user; (3) generating a login code from said second sequence; (4) comparing said login code to said account code; and (5) granting said user access to said resource if said login code matches said account code.

2. The method of claim 1 wherein said first image sections are arranged in a first grid.

3. The method of claim 2 wherein said first grid is rectangular.

4. The method of claim 1 wherein said second image sections are arranged in a second grid.

5. The method of claim 4 wherein said second grid is rectangular.

6. The method of claim 1 wherein said account code is generated using a cryptographic hash function and said login code is generated using said cryptographic hash function.

7. The method of claim 1 wherein said account code is generated using said first sequence and elements of said first image and said login code is generated using said second sequence and elements of said second image.

8. The method of claim 1 further comprising the steps of allowing said user to select said first image and allowing said user to select said second image.

9. The method of claim 1 further comprising the steps of assigning unique coordinates to each of said first sections, generating said account code from said coordinates corresponding to said sections of said first sequence, assigning said coordinates to each of said second sections, and generating said login code from said coordinates corresponding to said sections of said second sequence.

10. A method for authenticating a user for access to a restricted resource comprising the steps of:
(a) creating an account for said user comprising the steps of (1) presenting a first image to said user, said first image being divided into first sections arranged in a first grid; (2) assigning unique coordinates to each of said first sections; (3) accepting a first sequence of said first sections selected by said user; (4) generating an account code from said coordinates corresponding to said sections of said first sequence using a cryptographic hash function; and (5) storing said account code; and
(b) subsequently authenticating said user comprising the steps of (1) displaying a second image to said user, said second image being divided into second sections arranged in a second grid; (2) assigning said coordinates to each of said second sections; (3) accepting a second sequence of said second sections selected by said user; (4) generating a login code from said coordinates corresponding to said sections of said second sequence using said cryptographic hash function; (5) comparing said login code to said account code; and (6) granting said user access to said resource if said login code matches said account code.

11. The method of claim 10 wherein said first grid and said second grid are rectangular.

12. The method of claim 10 wherein said account code is generated using said first sequence and elements of said first image and said login code is generated using said second sequence and elements of said second image.

13. The method of claim 10 further comprising the steps of allowing said user to select said first image and allowing said user to select said second image.
